(19) United States
(12) Patent Application Publication
(10) Pub. No.: US 2004/0150526 A1
(43) Pub. Date: Aug. 5, 2004

(54) Method of informational advertising in restrooms

(76) Inventor: Javier Roberto De La Garza, Lethbridge (CA)

Correspondence Address: Glen F. Gallinger, #1000, 7420 Milner Dr., Colorado Springs, CO, 80920, US

(21) Appl. No.: 10/345,457

(22) Filed: Jan. 17, 2003

(51) Int. Cl. G09F 27/00

(52) U.S. Cl. 340/573.1; 40/455; 40/624; 40/361; 705/14

(57) ABSTRACT

Whenever individuals use a public restroom—whether they are shopping, dining, dancing, or attending a sporting/cultural event—they must physically stop, relax, and wait. It is an opportune time to target them with specific informational advertising. A method of providing informational messages to users of public restrooms comprises the steps of: providing a broadcasting device in a public restroom; providing a sensor to determine use of a portion of the public restroom proximate to the user; connecting the broadcasting device to a computer provided to convey a broadcast signal containing the message to the broadcasting device; and, providing and storing the informational message in the computer for subsequent dissemination to the broadcast device when the restroom is determined to be in use by the sensor. In a preferred aspect of the above method an internet connection to the computer is provided to facilitate updating the informational messages disseminated from the computer to the broadcasting device.

### FIELD OF THE INVENTION

This invention relates to advertising and promotion in public restrooms. More particularly this invention relates to a method of centrally distributing audio and video advertisements to consumers who are captive while engaged in the use of a public restroom.

### BACKGROUND OF THE INVENTION

Whenever individuals use a public restroom—whether they are shopping, dining, dancing, or attending a sporting/cultural event—they are temporarily suspended from activity. It is mandatory they physically stop, relax, and wait for their body to complete its process of elimination. At this time of relaxation the individual is not only a captive audience, but additionally the individual is temporarily disconnected from his immediate course of action. This is an opportune time to present the individual with informational advertising.

This advertising can be targeted to the type of individual who is shopping at the specific location of the restroom, who is attending a specific sporting event, or a particular cultural activity. Alternatively, the advertisement may suggest a current sales promotion at a business in the immediate vicinity, or simply event related activities or products likely to be of interest. Frequently, within minutes after individuals are exposed to an informational advertisement in a public restroom they will be actively engaged in making purchasing decisions.

Ideally the advertising should present a substantial amount of information. The individual's attention should be largely available for a few minutes. Full motion and sound are the best way to capture attention and present much information from a relatively small wall space. Additionally, it is most advantageous if the informational message is readily able to be changed. Different productions in a cultural center may attract different groups of individuals, each group having different interests.

### OBJECTS OF THE INVENTION

It is an object of this invention to disclose a unique method of targeting a consumer with known interests with an informational message of interest to him. It is an object of this invention to disclose a method of exposing a consumer with a relevant informational message when they are temporarily disengaged from purchasing and when they are largely unfocused and open to fully considering the informational message. It is yet a further object of this invention to disclose a method of targeting a consumer with an informational advertising message within minutes of a time when they are in a position to complete the transaction which was suggested in the advertising message. It is a final object of this invention to disclose a method of conveniently and timely disseminating specific and relevant information to individuals immediately before that information may be needed and used.

One aspect of this invention provides for a method of providing informational messages to users of public restrooms comprising the steps of: providing a broadcasting device in a public restroom; providing a sensor to determine use of a portion of the public restroom proximate to the user; connecting the broadcasting device to a computer provided to convey a broadcast signal containing the message to the broadcasting device; and, providing and storing the informational message in the computer for subsequent dissemination to the broadcast device when the restroom is determined to be in use by the sensor.

In a preferred aspect of this invention the above method comprises the additional step of providing an internet connection to the computer to facilitate updating the informational messages disseminated from the computer to the broadcasting device.

Various other objects, advantages and features of this invention will become apparent to those skilled in the art from the following description in conjunction with the accompanying drawings.

### FIGURES OF THE INVENTION

FIG. 1 is a schematic diagram showing the interconnection, and the components utilized in the method of informational advertising in restrooms.

FIG. 2 is a perspective view of a protective display cover assembly for a monitor.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

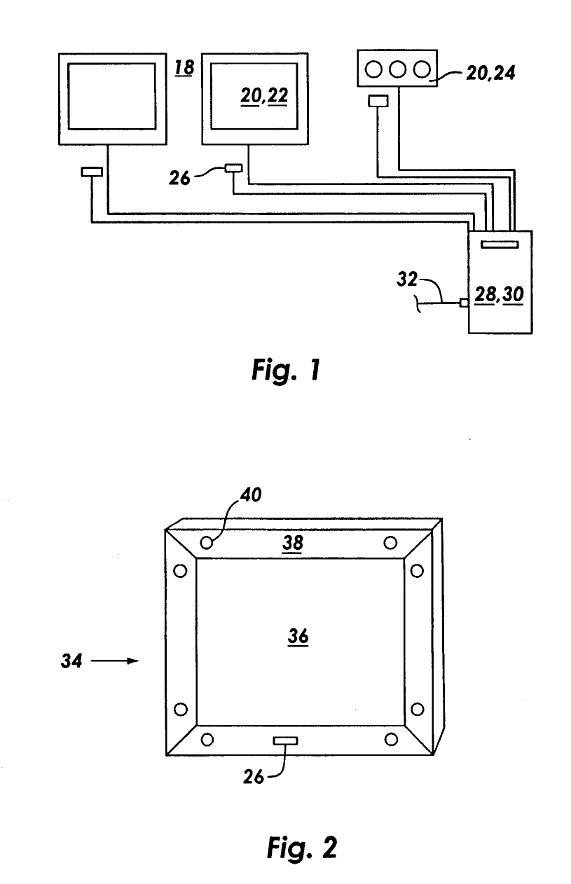

Turning now to the drawings and more particularly to FIG. 1 we have a schematic diagram showing the interconnection, and the components utilized in the method of informational messaging in a public restroom 18. Most basically, a method of providing informational messages to users of public restrooms 18 comprising the steps of: providing a broadcasting device 20 in a public restroom 18; providing a sensor 26 to determine use of a portion of the public restroom 18 proximate to the user; connecting the broadcasting device to a computer 28 provided to convey a broadcast signal containing the informational message to the broadcasting device 20; and, providing and storing the informational message in the computer for 28 subsequent dissemination to the broadcast device 20 when the restroom 18 is determined to be in use by the sensor 26. Within this application a broadcasting device is intended to include a device broadcasting sound alone or a device including both video and sound.

In a preferred aspect of the invention, the above method further comprises the step of providing an internet connection 32 to the computer 28 to facilitate updating the informational messages disseminated from the computer 28 to the broadcasting device 20. Most preferably the computer 28 comprises a server 30 and there are multiple sensors 26 and broadcasting devices 20. To best engage the attention of restroom 18 users a broadcasting device 20 is most preferably not just an audio speaker but a video monitor 22 (which includes an audio speaker).

It is anticipated that broadcast devices 20 will be positioned in different use areas of a public restroom 18. For example such monitors may be positioned in individual toilet cubicles, at individual urinals, as well as adjacent to sinks and hand dryers. Accordingly, it is anticipated that there be multiple informational messages of different durations and that the server 30 be programmed to deliver a message of a predetermined duration to a particular broadcasting device in a public restroom based on an anticipated duration of use of the particular location in the restroom 18.

It is also anticipated that there will be multiple servers individually positioned at different types of establishments. Accordingly, the informational message at a particular server should be configured to be of interest to a user at the particular type of establishment at which it is broadcast. Informational messages are intended to include not only informational advertising, but additionally timely information relating to time dated sales promotions, as well as building and location information. Accordingly, at a particular public restroom 18 the informational message can be targeted to be of interest to the user of that particular restroom at a particular time of use.

In particular locations a video projector, which is most preferably an LCD projector, can advantageously present an enlarged image onto a white board or plain wall in the restroom 18. However it is anticipated that most frequently, flat screen monitors 22 will be employed as broadcasting devices 20.

FIG. 2 is a perspective view of a protective display cover assembly 34 for a monitor 22. A protective display cover assembly comprises a transparent viewing portion 36 surrounded by a metal frame 38. The frame 38 is provided with spaced holes 40 to accommodate mounting bolts (not shown). The transparent viewing portion may either be made of scratch proof plexiglass or bullet proof glass. Most preferably the sensor 26 is housed within the frame 38.

In the most preferred aspect of the method, the preliminary step of entering into rental agreements with owners of public restrooms 18, and the subsequent step (to the above listed steps) of selling advertising spots within the informational messages to interested businesses is included in the method. Selling prices for broadcasting informational messages within public restrooms should be based on the frequency which the informational messages are broadcast, during the use of public restrooms, in combination with the length of time each informational message takes to be broadcast.

While the invention has been described with preferred specific embodiments thereof, it will be understood that this description is intended to illustrate and not to limit the scope of the invention, which is defined by the following claims.

I claim:

1) A method of providing informational messages to users of public restrooms comprising the steps of:
providing a broadcasting device in a public restroom;
providing a sensor to determine use of a portion of the public restroom proximate to the user;
connecting the broadcasting device to a computer provided to convey a broadcast signal containing the message to the broadcasting device; and,
providing and storing the informational message in the computer for subsequent dissemination to the broadcast device when the restroom is determined to be in use by the sensor.

2) A method as in claim 1 further comprising the step of providing an internet connection to the computer to facilitate updating the informational messages disseminated from the computer to the broadcasting device.

3) A method as in claim 2 wherein the computer comprises a server and wherein there are multiple sensors and broadcasting devices, and wherein each broadcasting device comprises audio speakers and a video monitor.

4) A method as in claim 3 wherein there are multiple informational messages of different durations and wherein the server is programmed to deliver a message of a predetermined duration to a particular broadcasting device in a public restroom based on an anticipated duration of use of the particular location in the restroom.

5) A method as in claim 3 wherein there are multiple servers individually positioned at different types of establishments and wherein the informational message at a particular server is configured to be of interest to a user at the particular type of establishment at which it is broadcast.

6) A method as in claim 5 wherein the informational message is targeted to be of interest to the user of a particular restroom at a particular time.

7) A method as in 5 wherein the informational message comprises informational advertising.

8) A method as in claim 6 wherein the informational message comprises building and location information.

9) A method as in claim 4 wherein one of the broadcasting devices comprises a video projector.

10) A method as in claim 4 wherein one of the broadcasting devices comprises a flat screen monitor having a protective display cover comprising a transparent viewing portion surrounded by a metal frame, and wherein the sensor is housed within the frame.

11) A method as in claim 7 further comprising the preliminary step of entering into rental agreements with owners of public restrooms, and the subsequent step of selling advertising spots within the informational messages to interested businesses.
